(19) United States
(12) Patent Application Publication
(10) Pub. No.: US 2007/0023502 A1
(43) Pub. Date: Feb. 1, 2007

(54) Composite electronic card device

(76) Inventors: Ming-Chih Tsai, Shindian City (TW); Tzu-Chieh Hsiung, Shindian City (TW); Wang-Sheng Ni, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/188,753

(22) Filed: Jul. 26, 2005

(51) Int. Cl. G06K 5/00; G06K 19/06

(52) U.S. Cl. 235/380; 235/492

(57) ABSTRACT

A composite electronic card device is disclosed, comprising an erasable nonvolatile memory, a random access memory (RAM) . . . , CPU, cryptographic module and other electronic components. Through different cryptographic algorithms, different security application systems may arrange and configure different application program or data block required and application software, keys, password, key authentication an personal data may be written into the arranged application program or data blocks. As such, the different security applications systems may be accessed by the single composite electronic card device.

### BACKGROUND OF THE INVENTION

1. Field of the Invention

The present invention relates to a smart card or Portable security device portable security device. More particularly, the present invention relates to a composite electronic card device.

2. Description of the Prior Art

As the human society changes, things tend to be electronized. Responsive to this, a diversity of electronic security systems have been developed and produced, such as electronic locks for door guard, electronic locks for personal computers (PCs), access control of computer systems, electronic door locks or engine locks for vehicles, various electronic pass certificates or passwords, digital certificates and keys for public key infrastructures, access control and management of portable security Portable security devices, smart cards for driver's licenses, smart cards for banking business and key security storage media of universal serial bus (USB) interface.

Since such electronic security systems are utilized in various fields and card readers corresponding to these systems and fields are not identical and compatible, users of such systems encounter considerable inconvenience.

Generally, mechanism of each of such electronic security systems is specific in authentication standard and encryption process as compared to the others. In the case that two such systems have different authentication standards and encryption processes, the chip card and card reader for one of such systems may not be used in the other system. In this case, a user of the chip cards has to have several such cards in hand when different such systems have to be accessed. Take the currently popular traffic systems, mass rapid transportation and train, as an example. Although stored value cards have been widely adopted by the mass rapid transportation and train systems as pass certificates, the stored value cards of one of the two systems may not be used in the other system, leading to inconvenience to the user. In addition, if the user also has a card for door unlock, inconvenience would be further caused. Such inconvenience of identification and carry of the electronic cards are nagging the users and thus a device which may integrate the functions of various electronic cards are long-felt in the related filed.

### SUMMARY OF THE INVENTION

It is, therefore, an object of the present invention to provide a composite electronic card device in which a plurality of electronic cards for different electronic security systems, such as a smart card, an electronic key and an portable security device are integrated.

According to the present invention, the composite electronic card device has different electronic security systems integrated therein, such as various electronic cards, integrated chip (IC) smart cards, electronic keys, portable security devices. The composite electronic card device has a read only memory (ROM) for storing an operating system, a random access memory (RAM), an eclectically erasable programmable ROM (EEPROM) for storing application data and a central processing unit (CPU). In the composite electronic card device, a main control program is used to manage application programs required for a plurality of security application systems so as to provide resources for control of the composite electronic card device and instructions required for system control.

As such, the security application systems may be integrated in the composite electronic card device and may each be independently accessed, possessing security, consistency and convenience. Therefore, a main control system and thus the operating system may be used for all the security application system programs, reducing complexity of the integrated security application system. Each of the security application system arranges a new application program and data block in the memory for storage of personal data, key type, key content, sensitive data and the like. Before accessing a specific data block, the security application system has to be authenticated in authority so that the other security application systems may not be invaded and privacy thereof may be maintained. Consequently, convenience and security of the composite electronic card device may be well provided.

In alternative embodiments, a universal serial bus (USB) interface and radio frequency (RF) communication interface may be combined into the composite electronic card device so that the composite electronic card device may find a wider application range.

### BRIEF DESCRIPTION OF THE DRAWINGS

The drawings disclose an illustrative embodiment of the present invention which serves to exemplify the various advantages and objects hereof, and are as follows:

FIG. 1 is a diagram showing a hardware arrangement of a composite electronic card device according to the present invention; and

FIG. 2 is a diagram showing an application of the composite electronic card device according to the present invention.

### DETAILED DESCRIPTION OF THE PREFERRED EMBODIMENT

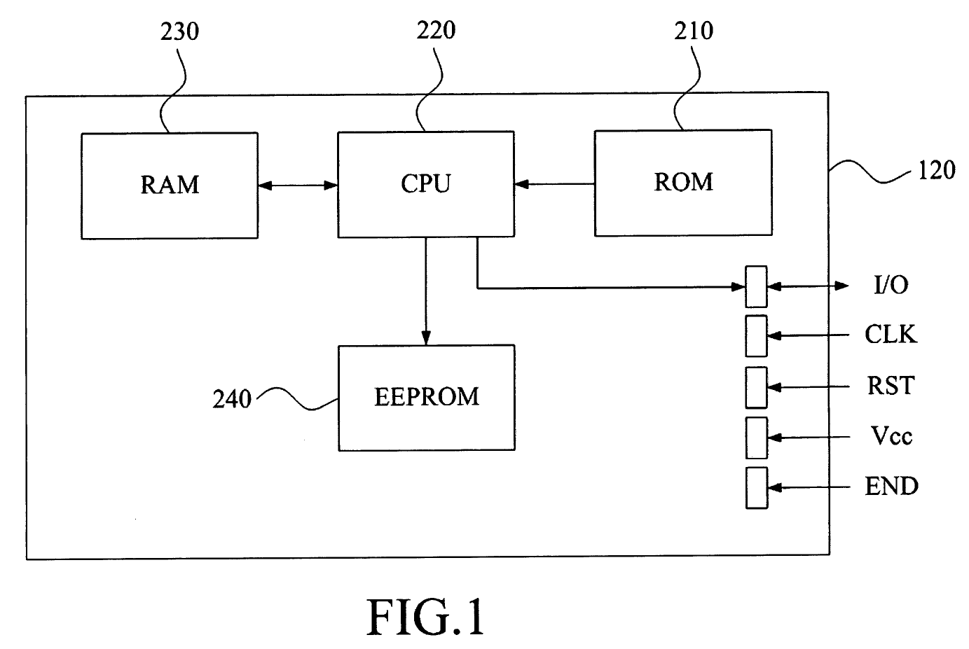

Referring to FIG. 1, a hardware arrangement of a composite electronic card device according to the present invention is shown therein. In the composite electronic card device 120, a memory 210, a central processing unit (CPU) 220, a random access memory (RAM) 230 and a flash memory or electrically erasable and programmable ROM (EEPROM) 240 are provided. The memory 210 is provided for storage of an operating system of the electronic card device 120 and may be a read only memory (ROM), a flash memory and a one-time programmable (OTP) EPROM. The memory 210 is written with a program through a masking mechanism when a chip corresponding to the composite electronic card device is manufactured and may not be written again but may only be read. In the case of the flash memory, the memory 210 may achieve the read only function through a software and hardware control manner. The operating system and executable codes are stored in the memory 210 for enhancement of security of the chip. The RAM 230 is a volatile memory and thus contents therein disappear as the power is not continuously supplied. Further, the RAM 230 may serve as a buffer for variables, registers, stacks, ciphers and output/input when the program is executed.

The EPROM 240 is a nonvolatile memory and used to store data therein, such as personal data, identification card number, bank account and student ID number of the card holder. The EPROM 240 may also be replaced by such as a flash memory. The CPU 220 is a heart of the composite electronic card, which may be any micro processor, for example, Motorola 6805 or Intel 8051, and used to process data. Also shown in FIG. 1 are connections for I/O signals of USB specification (I/O), a clock signal (CLK), a reset signal controlled externally (RST), an external power signal (Vcc) and a ground signal (GND).

Generally, an electronic card may be issued to the user for use only after the operating system and execution files such as application software are written into the ROM and information such as personal data are written through a normal card initialization process. The memory in the electronic card may be arranged by the card issuer. In this invention, a plurality of data blocks are arranged in the EPROM for storage of application system software, keys and key authentication required for different application systems.

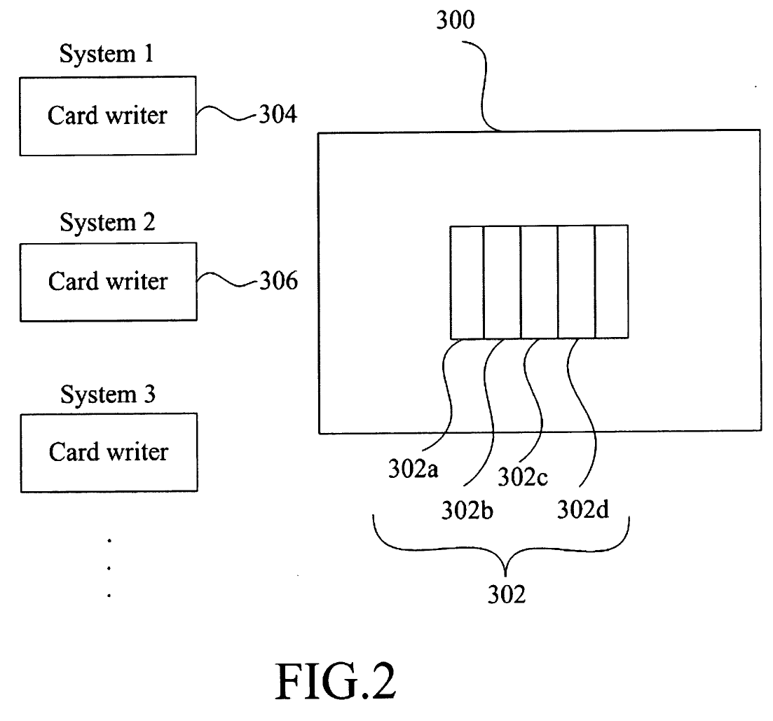

Referring to FIG. 2, a diagram of an application of the composite electronic card is shown therein. In the composite electronic card 300, a main control area and a main control key are first generated and then the data blocks required for the system software, keys and key authentication for the application systems are arranged in the EPROM by the application systems. The main control key is provided to control a subsequent card writing process and management of the application systems. It is to be noted that security systems used with the composite electronic card of the invention have to provide a common communications protocol. In addition, the composite electronic card of the invention may be used with equipment or terminal containing secure access module (SAM) (e.g. a card reader or writer or a point of sale (POS) system) external to the card device so that a secure card initialization process or data read and write operation may be achieved. As such, it may be assured that data in the composite electronic card is properly accessed by authenticated external equipments.

When the composite electronic card 300 is finished with the card initialization process, it may be written with the required system software, keys and key authentications by the corresponding application systems. For example, System 1 is a door guard system accessible by electronic cards and by which the system software, key and key authentication corresponding thereto may be written into the arranged data block 302a through a card writer 302 of System 1. Similarly, assuming System 2 is an electronic pass certificate in a form of the electronic card, the system software, key and key authentication corresponding thereto may be written in to the arranged data blocks 302b through a card writer of System 2. It is to be noted that authority of the main control key of each of the application systems (System 1, System 2, System 3, . . . ) is limited in data block access such as creation, writing and reading of the system and corresponding application software, key and key authentication with respect to the subject application system. As such, the key of one of the application systems associated with the composite electronic card device of the invention may not be unauthorized accessed or stolen by other application systems associated with the same physical device.

In conclusion, a plurality of electronic cards may be integrated in the composite electronic card device of this invention. By means of the single electronic card device, the user may access the security systems corresponding to the plurality of electronic card applications. For example, in case that the user buys a new car equipped with such security system, the user may integrated the corresponding electronic card application into the composite electronic card device of the invention by requesting the manufacturer of the security system associated with the car to configure a code and data block in the memory of the composite electronic card device and download the required system or application software, key and key authentication into the configured code and data block. In this case, the electronic card originally provided by the manufacturer may be saved and replaced by the composite electronic card device of the invention, through which inconvenience caused by carry of multiple electronic cards may be avoided.

Preferably, one time password (OTP) mechanism may be combined in the composite electronic card device of the invention so that security of the password authentication and data transmission may be further guaranteed. For example, the OTP may be combined with personal identification number (PIN) of a card holder to generate a dynamic authentication code through the authentication to make the electronic security system deactivated.

In addition, a universal serial bus (USB) interface may be additionally provided for the composite electronic card device of the invention so that the composite electronic card device may be used in more applications. For example, the device with USB interface may be used as a authentication token to unlock the screen lock of a computer. Alternatively, radio frequency (RF) technology may also be built in the composite electronic card device as an external communication interface so that the internal data may be wirelessly accessed by the contactless card reader, which further facilitates use of the composite electronic card device of the invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A composite electronic card device, comprising:
a central processing unit (CPU);
a read only or nonvolatile memory connected to the CPU and storing an operating system;
a random access memory (RAM) connected to the CPU an being a register for data input and output; and
a plurality of memory blocks storing software, keys and key authentication of a plurality of systems and located within an erasable memory.

2. The composite electronic card device according to claim 1, wherein the erasable memory comprises a memory, an erasable non-volatile memory and a one-time programmable (OTP) EPROM.

3. The composite electronic card device according to claim 1, wherein the erasable memory comprises an erasable programmable read only memory (EPROM).

4. The composite electronic card device according to claim 1, wherein the erasable memory comprises a flash memory and an electrically EPROM (EEPROM).

5. The composite electronic card device according to claim 1, further comprising a universal serial bus (USB) interface.

6. The composite electronic card device according to claim 1, further comprising radio frequency (RF) communication interface.

7. The composite electronic card device according to claim 1, wherein the software generates a one-time password.

8. The composite electronic card device according to claim 1, wherein the plurality of memory blocks are each configured by a corresponding one of the plurality of systems.

9. The composite electronic card device according to claim 1, wherein data in each of the memory blocks is accessible only by a corresponding one of the plurality of systems.

10. A security apparatus, comprising:
a composite electronic card device, comprising:
a central processing unit (CPU);
a memory connected to the CPU and storing an operating system;
a random access memory (RAM) connected to the CPU an being a register for data input and output; and
a plurality of memory blocks storing software, keys and key authentication of a plurality of systems and located within an erasable memory; and
a plurality of card readers-and-writers each associated with a corresponding one of the plurality systems and each reading a corresponding one of the plurality of memory blocks,
wherein the plurality of card readers and writers have a same communication protocols as that of the composite electronic card device.

11. The security apparatus according to claim 10, wherein the memory comprises a memory, an erasable non-volatile memory and a one-time programmable (OTP) EPROM.

12. The security apparatus according to claim 10, wherein the erasable memory comprises an erasable programmable read only memory (EPROM).

13. The security apparatus according to claim 10, wherein the erasable memory comprises a flash memory.

14. The security apparatus according to claim 10, further comprising a universal serial bus (USB) interface.

15. The security apparatus according to claim 10, further comprising radio frequency (RF) communication interfac.

16. The security apparatus according to claim 10, wherein the software generates a one-time password.

17. The security apparatus according to claim 10, wherein the plurality of memory blocks are each arranged by a corresponding one of the plurality of systems.

18. The security apparatus according to claim 10, wherein data in each of the memory blocks is accessible only by a corresponding one of the plurality of systems.

19. The security apparatus according to claim 10, further comprising a plurality of secure access module (SAM) chips each integrated in the plurality of card readers and writers so that it is assured that data in the composite electronic device card are accessed by a proper one among the plurality of card readers/writers.
